(19) United States
(12) Patent Application Publication
(10) Pub. No.: US 2016/0092896 A1
(43) Pub. Date: Mar. 31, 2016

(54) METHOD AND SYSTEM FOR DETERMINING POLITICAL AFFILIATION AND ATTITUDE TRENDS

(71) Applicant: MASTERCARD INTERNATIONAL INCORPORATED, Purchase, NY (US)

(72) Inventor: Jean-Pierre Gerard, Croton-on-Hudson, NY (US)

(21) Appl. No.: 14/502,444

(22) Filed: Sep. 30, 2014

(51) Int. Cl. G06Q 30/02; G06Q 20/24

(52) U.S. Cl. CPC G06Q 30/0204; G06Q 20/24

(57) ABSTRACT

A method and a system are provided for determining political affiliation and/or attitude trends of a plurality of payment card holders. The method includes retrieving from one or more databases a first set of information comprising payment card transaction information of a plurality of payment card holders, and retrieving from the one or more databases a second set of information comprising external information. The external information comprises political affiliation and/or attitude information of a plurality of merchants, and political affiliation and/or attitude information of the plurality of payment card holders. The method also includes analyzing the first set of information and the second set of information to identify one or more associations between the payment card transaction information and the external information, and determining political affiliation and/or attitude trends of the plurality of payment card holders based on the one or more associations. The method and system can be used to measure shifts in ideological and political patterns of a population.

### BACKGROUND OF THE DISCLOSURE

1. Field of the Disclosure

The present disclosure relates to a method and a system for dynamically determining political affiliation and/or attitude (e.g., ideological) trends of a plurality of payment card holders. The method and system can be used to predict political affiliation and/or attitude trends present in a population, and measure shifts in political affiliations and/or attitudes of a population. The method and system can also be used for research purposes.

2. Description of the Related Art

Studies tracking the political mood, affiliation and attitude of a population and measuring shifts in ideological and political patterns of a population are currently performed by polling a sample of that population. Polling is utilized in politics to gauge the public's attitude toward a person or issue, to learn what message could persuade a particular type of voter to support a particular person or issue, and to measure shifts in ideological and political patterns of a population. Polls can measure candidate viability through the ballot test question, and evaluate the effectiveness of a particular communication strategy. For instance, polling allows a representative sample of 1,000 people to share their opinions on a candidate or issue, thereby providing the researcher the ability to extrapolate such findings to the overall population.

Polling provides data on key segments of constituents of the population's affiliations and attitudes toward a particular issue in contrast to the overall population. Standpoint theory affirms that it is problematic to truly understand someone else's perspective of the world because each of us is shaped by multiple factors and individual's experiences. Polling provides a vehicle to understand trends, similarities and differences of subgroups within the general population.

There have been many changes in collection methods of data over the last one hundred years. For instance, the straw poll, which was popular in the 19th century, now is viewed more as a fundraising gimmick, rather than a legitimate and accurate measurement of public opinion.

Direct mail and face to face interviews for data collection were the most popular techniques used in the early 20th century. Direct mail continued to be popular into the late 1980. Yet, the increase cost of postage and the decrease in responses adversely impacted the reliability of this data collection method. The face-to-face interview also became too costly, and was hampered by potential interviewer bias. In response, the modern polling industry adopted the telephone as its favored means of data collection.

Live operator phone calls continue to be the standard practice because they allow access to most of the population and, in addition, there is also no limit on what sample of the population you can access via cell phones.

For the last decade, telephone data collection has evolved with Voice Over Internet Protocol (VOIP) and Interactive Voice Recognition (IVR) software, known as auto calls or robo-calls. This system of data collection allows for a pre-recorded message to be played to all recipients. Recipients respond with keypads to enter their choices. IVR data collection is becoming known for its accuracy.

One explanation for the accuracy of IVR data collection is the trend for increased automation in people's day to day lives, including touch systems for customer service, self-banking and even self-checkout at stores. However, there are challenges as IVR may lose its legitimacy in data collection, given that the FCC has made it illegal to call cell phones which limit the sampling frame.

Internet data collection is growing in popularity with the ability to ask longer questioners and having a representative sample.

Two key measures regarding polling are validity and reliability. Validity asks are we studying what we claim to be studying and reliability looks at the consistency of the results. Such factors including the time of day a survey is administered, the day of the week, weather factors, among others can influence the results and lower the reliability of the data.

Thus, there is a need for alternatives to conventional methods of polling and tracking the political mood, affiliation and attitude of a population and measuring shifts in ideological and political patterns of a population that are not affected by the several factors above that can influence the results and lower the reliability of the data.

### SUMMARY OF THE DISCLOSURE

The present disclosure provides a method and a system for dynamically determining political affiliation and/or attitude (e.g., ideological) trends of a plurality of payment card holders. In particular, the present disclosure relates to a method and a system for dynamically determining political affiliation and/or attitude trends of a plurality of payment card holders based on payment card transaction information and external information. The external information comprises political affiliation and/or attitude information of a plurality of merchants, and political affiliation and/or attitude information of the plurality of payment card holders. The method and system can be used to predict political affiliation and/or attitude trends of a population, and measure shifts in political affiliations and/or attitudes of a population. The method and system can also be used for research purposes.

The present disclosure also provides a method that includes retrieving from one or more databases a first set of information comprising payment card transaction information of a plurality of payment card holders, and retrieving from the one or more databases a second set of information comprising external information. The external information comprises political affiliation and/or attitude information of a plurality of merchants, and political affiliation and/or attitude information of the plurality of payment card holders. The method also includes analyzing the first set of information and the second set of information to identify one or more associations between the payment card transaction information and the external information, and determining political affiliation and/or attitude trends of the plurality of payment card holders based on the one or more associations.

The present disclosure further provides developing logic for predicting political affiliation and/or attitude trends, and applying the logic to a universe of payment card transaction information and external information to determine political affiliation and/or attitude trends of the plurality of payment card holders.

The present disclosure also provides a system that includes one or more databases including a first set of information comprising payment card transaction information of a plurality of payment card holders; and one or more databases including a second set of information comprising external information. The external information comprises political affiliation and/or attitude information of a plurality of merchants, and political affiliation and/or attitude information of the plurality of payment card holders. The system also includes a processor configured to: analyze the first set of information and the second set of information to identify one or more associations between the payment card transaction information and the external information; and determine political affiliation and/or attitude trends of the plurality of payment card holders based on the one or more associations.

The present disclosure further provides a system in which the processor is configured with a programmed logic to predict political affiliation and/or attitude trends. The present disclosure yet further provides a system in which the processor is configured to apply the logic to a universe of payment card transaction information and external information to determine political affiliation and/or attitude trends of the plurality of payment card holders.

The present disclosure still further provides a method that includes retrieving from one or more databases a first set of information comprising payment card transaction information of a plurality of payment card holders; and retrieving from the one or more databases a second set of information comprising external information in which the external information comprises political affiliation and/or attitude information of a plurality of merchants, and political affiliation and/or attitude information of the plurality of payment card holders. The method also includes analyzing the first set of information and the second set of information to identify one or more associations between the payment card transaction information and the external information; extracting information related to an intent of the plurality of payment card holders based on the one or more associations; generating one or more predictive behavior models based on the one or more associations and the intent of the plurality of payment card holders; and assessing political affiliation and/or attitude trends of the plurality of payment card holders based on the one or more predictive behavioral models.

The present disclosure also provides a method and a system that predict political affiliation and/or attitude (e.g., ideological) trends in a population, and measure shifts in political affiliations and/or attitudes of a population.

### BRIEF DESCRIPTION OF THE DRAWINGS

FIG. 1 is a diagram of a four party payment card system.

FIG. 2 illustrates a data warehouse shown in FIG. 1 that is a central repository of data that is created by storing certain transaction data from transactions occurring in four party payment card system of FIG. 1.

FIG. 3 is a block diagram of a portion of a payment card system used in accordance with the present disclosure.

FIG. 4 shows illustrative information types used in the systems and the methods of the present disclosure.

FIG. 5 illustrates an exemplary dataset for the storing, reviewing, and/or analyzing of information used in the systems and the methods of the present disclosure.

FIG. 6 is a flow chart illustrating a method of determining political affiliation and/or attitude trends of a plurality of payment card holders, in accordance with exemplary embodiments of the present disclosure.

FIG. 7 is a block diagram of a method of generating political affiliation and/or attitude trends of a plurality of payment card holders, in accordance with exemplary embodiments of the present disclosure.

FIG. 8 is a flow chart illustrating a method of assessing political affiliation and/or attitude trends of a plurality of payment card holders based on predictive behavioral models, in accordance with exemplary embodiments of the present disclosure.

A component or a feature that is common to more than one drawing is indicated with the same reference number in each drawing.

### DESCRIPTION OF THE EMBODIMENTS

Embodiments of the present disclosure are described more fully hereinafter with reference to the accompanying drawings, in which some, but not all, embodiments of the present disclosure are shown. Indeed, the present disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for a particular product, charity, not-for-profit organization, labor union, local government, government agency, or political party. It should be understood that the methods and systems of this disclosure can be practiced by a single entity or by multiple entities. Although different entities can carry out different steps or portions of the methods and systems of this disclosure, all of the steps and portions included in the methods and systems of this disclosure can be carried out by a single entity.

As used herein, the one or more databases configured to store the first set of information or from which the first set of information is retrieved, and the one or more databases configured to store the second set of information or from which the second set of information is retrieved, can be the same or different databases.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage device, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, systems, methods and computer programs are herein disclosed to retrieve from one or more databases a first set of information comprising payment card transaction information of a plurality of payment card holders, and retrieve from the one or more databases a second set of information comprising external information. The external information comprises political affiliation and/or attitude information of a plurality of merchants, and political affiliation and/or attitude information of the plurality of payment card holders. The first set of information and the second set of information are analyzed to identify one or more associations between the payment card transaction information and the external information. Political affiliation and/or attitude (e.g., ideological) trends of the plurality of payment card holders are determined based on the one or more associations.

Among many potential uses, the systems and methods described herein can be used: (i) to predict political affiliation and/or attitude trends in a population; (ii) to measure shifts in political affiliations and/or attitudes of a population; and (iii) for research purposes. Other uses are possible.

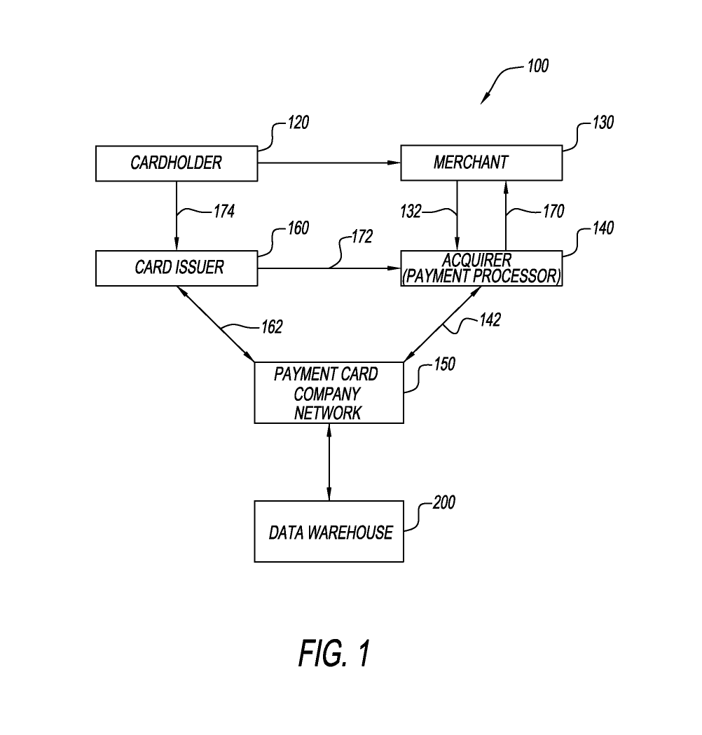

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes a financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, if the transaction is approved, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

Data warehouse 200 is a database used by payment card company network 150 for reporting and data analysis. According to one embodiment, data warehouse 200 is a central repository of data that is created by storing certain transaction data from transactions occurring within four party payment card system 100. According to another embodiment, data warehouse 200 stores, for example, the date, time, amount, location, merchant code, and merchant category for every transaction occurring within payment card network 150.

In yet another embodiment, data warehouse 200 stores, reviews, and/or analyzes information used in (i) identifying one or more associations between the payment card transaction information and the external information, (ii) determining political affiliation and/or attitude trends of the plurality of payment card holders based on the one or more associations, (iii) generating one or more predictive behavior models based on the one or more associations and the intent of the plurality of payment card holders, and (iv) assessing political affiliation and/or attitude trends of the plurality of payment card holders based on the one or more predictive behavioral models.

In still another embodiment, data warehouse 200 stores, reviews, and/or analyzes information used in creating one or more datasets to store information relating to (i) one or more associations between the payment card transaction information and the external information, (ii) political affiliation and/or attitude trends of the plurality of payment card holders based on the one or more associations, (iii) one or more predictive behavior models based on the one or more associations and the intent of the plurality of payment card holders, and (iv) political affiliation and/or attitude trends of the plurality of payment card holders based on the one or more predictive behavioral models.

In another embodiment, data warehouse 200 stores, reviews, and/or analyzes information used in developing logic for (i) identifying one or more associations between the payment card transaction information and the external information, (ii) determining political affiliation and/or attitude trends of the plurality of payment card holders based on the one or more associations, (iii) generating one or more predictive behavior models based on the one or more associations and the intent of the plurality of payment card holders, and (iv) assessing political affiliation and/or attitude trends of the plurality of payment card holders based on the one or more predictive behavioral models.

In still another embodiment, data warehouse 200 stores, reviews, and/or analyzes information used in quantifying the strength of the (i) one or more associations between the payment card transaction information and the external information, (ii) political affiliation and/or attitude trends of the plurality of payment card holders based on the one or more associations, (iii) one or more predictive behavior models based on the one or more associations and the intent of the plurality of payment card holders, and (iv) political affiliation and/or attitude trends of the plurality of payment card holders based on the one or more predictive behavioral models.

In still another embodiment, data warehouse 200 stores, reviews, and/or analyzes information used to predict political affiliation and/or attitude trends of a plurality of payment card holders, and measure shifts in political affiliations and/or attitudes of a plurality of payment card holders.

In another embodiment, data warehouse 200 aggregates the information by payment card holder, merchant, category and/or location. In still another embodiment, data warehouse 200 integrates data from one or more disparate sources. Data warehouse 200 stores current as well as historical data and is used for creating reports, performing analyses on the network, merchant analyses, and performing predictive analyses of political affiliation and/or attitude trends of a plurality of payment card holders.

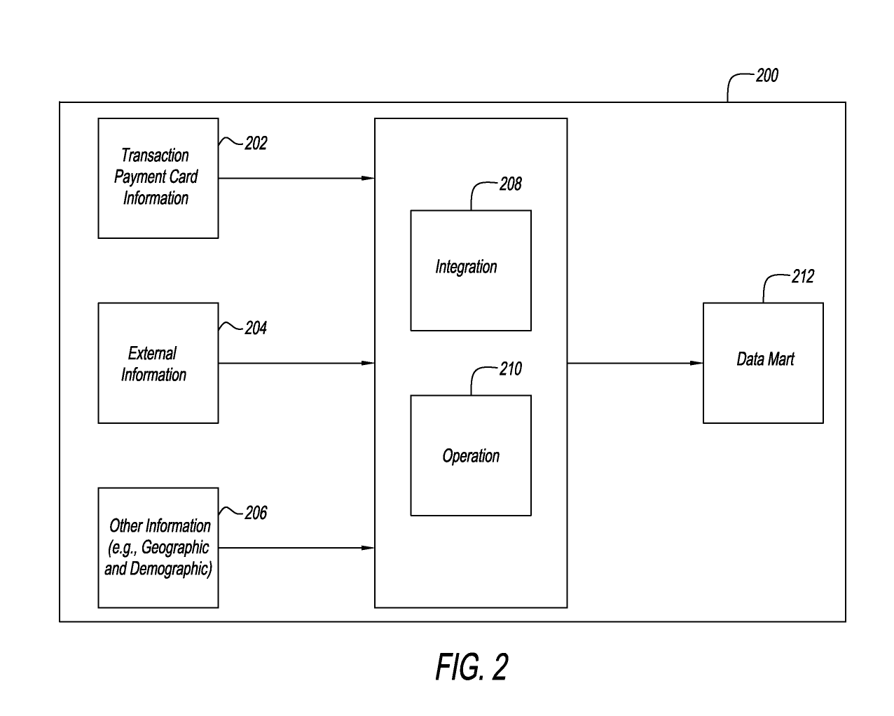

Referring to FIG. 2, an exemplary data warehouse 200 (the same data warehouse 200 in FIG. 1) for reporting and data analysis, including the storing, reviewing, and/or analyzing of information, for the various purposes described above is shown. The data warehouse 200 can have a plurality of entries (e.g., entries 202, 204 and 206).

The transaction payment card information 202 can include, for example, payment card transaction information, payment card holder information, and purchasing and payment activities attributable to payment card holders, that can be aggregated by payment card holder, category and/or location in the data warehouse 200. The transaction payment card information 202 can also include, for example, a transaction identifier, geolocation of payment card transaction, geolocation date on which payment card transaction occurred, geolocation time on which payment card transaction occurred, merchant information, and the like.

The merchant information can include, for example, categories of merchants, and the like. The merchant information can also include, for example, a merchant identifier, geolocation of merchant, and the like.

The external information 204 can include, for example, merchant political affiliations and/or attitudes (e.g., political membership organizations, campaign donations, politically leaning charitable organizations), and payment card holder political affiliations and/or attitudes (e.g., list of payment card holders and their political affiliations, survey data, voter registration, and the like, and aggregate affiliation data such as party affiliation by geography or demographic segments). The external information can be categorized, for example, by party affiliation, by geography or demographic segments, and the like. The external information can be clustered by category, for example, by political party, political activities, events, or other categories.

The other information 206 includes, for example, geographic data, firmographic data, and demographic data. The other information 206 can include other suitable information that can be useful in identifying one or more associations between the payment card transaction information and the external information, determining political affiliation and/or attitude trends of the plurality of payment card holders based on the one or more associations, generating one or more predictive behavior models based on the one or more associations and the intent of the plurality of payment card holders, and assessing political affiliation and/or attitude trends of the plurality of payment card holders based on the one or more predictive behavioral models.

The typical data warehouse uses staging, data integration, and access layers to house its key functions. The staging layer or staging database stores raw data extracted from each of the disparate source data systems. The integration layer integrates at 208 the disparate data sets by transforming the data from the staging layer often storing this transformed data in an operational data store database 210. For example, the payment card transaction information 202 can be aggregated by merchant, category and/or location at 208. Also, the reporting and data analysis, including the storing, reviewing, and/or analyzing of information, for the various purposes described above, can occur in data warehouse 200. The integrated data is then moved to yet another database, often called the data warehouse database or data mart 212, where the data is arranged into hierarchical groups often called dimensions and into facts and aggregate facts. The access layer helps users retrieve data.

A data warehouse constructed from an integrated data source systems does not require staging databases or operational data store databases. The integrated data source systems can be considered to be a part of a distributed operational data store layer. Data federation methods or data virtualization methods can be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 212 is a small data warehouse focused on a specific area of interest. For example, the data mart 212 can be focused on one or more of reporting and data analysis, including the storing, reviewing, and/or analyzing of information, for any of the various purposes described above. Data warehouses can be subdivided into data marts for improved performance and ease of use within that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, online analytical processing, polling, and decision support. However, the means to retrieve and analyze data, to extract, transform and load data, and to manage the data dictionary are also considered essential components of a data warehousing system. Many references to data warehousing use this broader context. Thus, an expanded definition for data warehousing includes business intelligence tools, tools to extract, transform and load data into the repository, and tools to manage and retrieve metadata.

Algorithms can be employed to determine formulaic descriptions of the integration of the data source information using any of a variety of known mathematical techniques. These formulas in turn can be used to derive or generate one or more analyses and updates for analyzing, creating, comparing and identifying activities using any of a variety of available trend analysis algorithms. For example, these formulas can be used in the reporting and data analysis, including the storing, reviewing, and/or analyzing of information, for the various purposes described above.

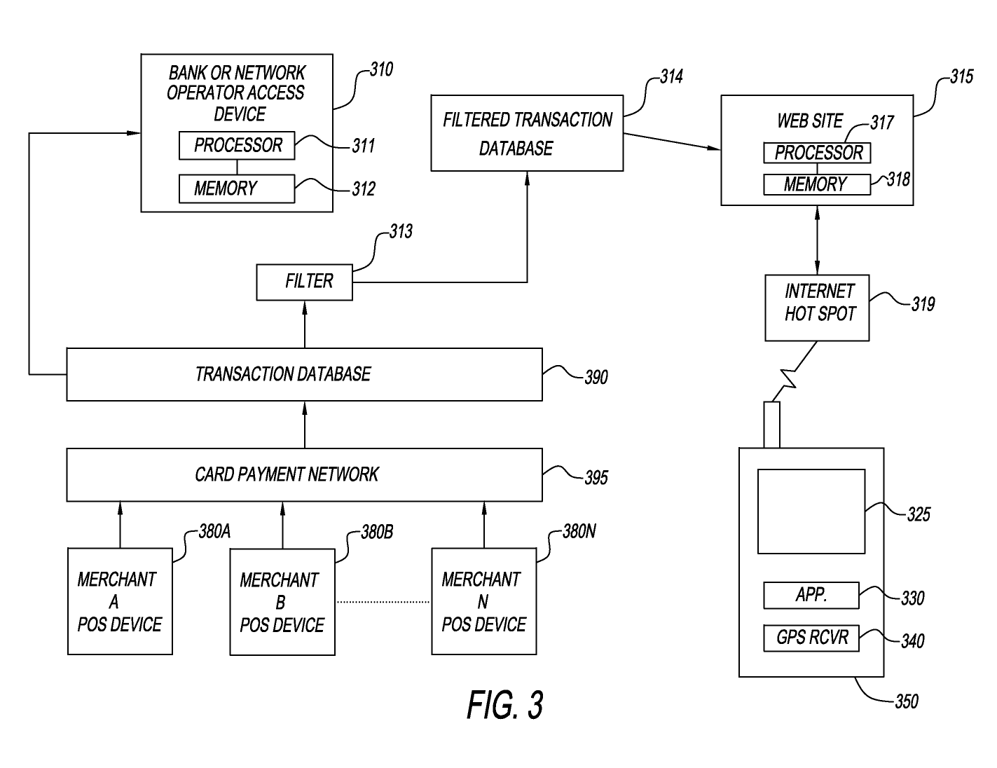

Referring to the drawings and, in particular, FIG. 3, a portion of a payment card system used in accordance with the present disclosure is shown. Each merchant that accepts a payment card has on their premises at least one card swiping machine or point of sale device 380, of a type well known in the art, for initiating customer transactions. These point of sale devices 380A, 380B, . . . 380N, generally have a keyboard data pad for entering data when a card's magnetic coding becomes difficult to read, or for the purpose of entering card data resulting from telephone calls during which the customer provides card data by telephone. Point of sale devices 380A, 380B, . . . 380N are connected by a suitable card payment network 385 (the payment card company network 150 in FIG. 1) to a transaction database 390 associated with or within network 395 that stores information concerning the transactions. The transaction database is included in the data warehouse 200 in FIGS. 1 and 2. An example of such a network 395 is BankNet operated by MasterCard International Incorporated. BankNet is a four party payment network that connects a card issuer, a card holder, merchants, and an acquiring bank, as is well known in the art. In another embodiment, network 395 can be a three party system. In any such embodiment, POS devices 380 do not have direct access to transaction database 390. It is the operator of network 395 that can access transaction database 390.

Information in database 390 can be accessed by a bank or network operator access device 310, such as a computer having a processor 311 and a memory 312. Users of device 310 can be employees of the bank or a payment network operator who are doing research or development work, such as running inquiries, to carry out the reporting and data analysis, including the storing, reviewing, and/or analyzing of information, for the various purposes described above.

Transaction records stored in transaction database 390 include information that is highly confidential and must be maintained confidential to prevent fraud and identity theft. The transaction records stored in transaction database 390 can be anonymized by using a filter 313 that removes confidential information, but retains records concerning all of the other transaction related details discussed above, preferably in real time. Anonymized data is generally necessary for polling applications. The filtered data is stored in a filtered transaction database 314 that can be accessed as described below. The data in the filtered transaction database 314 can be stored in any type of memory including a hard drive, a flash memory, on a CD, in a RAM, or any other suitable memory.

The following example of an approach to accessing the data involves a mobile telephone. However, it is understood that that there are various other approaches, technologies and pathways that can be used, including direct access by employees of the card issuing bank or a payment network operator.

A mobile telephone 350 having a display 325 can have a series of applications or applets thereon including an applet or application program (hereinafter an application) 330 for use with the embodiment described herein. Mobile telephone 350 can also be equipped with a GPS receiver 340 so that its position is always known.

Mobile telephone 350 can be used to access a website 315 on the Internet, via an Internet connected Wi-Fi hot spot 319 (or by any telephone network, such as a 3G or 4G system, on which mobile telephone 350 communicates), by using application 330. Website 315 is linked to database 314 so that authorized users of website 315 can have access to the data contained therein. These users can be employees of the bank or a network operator who is making inquiries as described above with bank or operator access device 310.

Web site 315 has a processor 317 for assembling data from filtered transaction database 314 for responding to inquiries. A memory 318 associated with web site 315 having a non-transitory computer readable medium, stores computer readable instructions for use by processor 317 in implementing the operation of the disclosed embodiment.

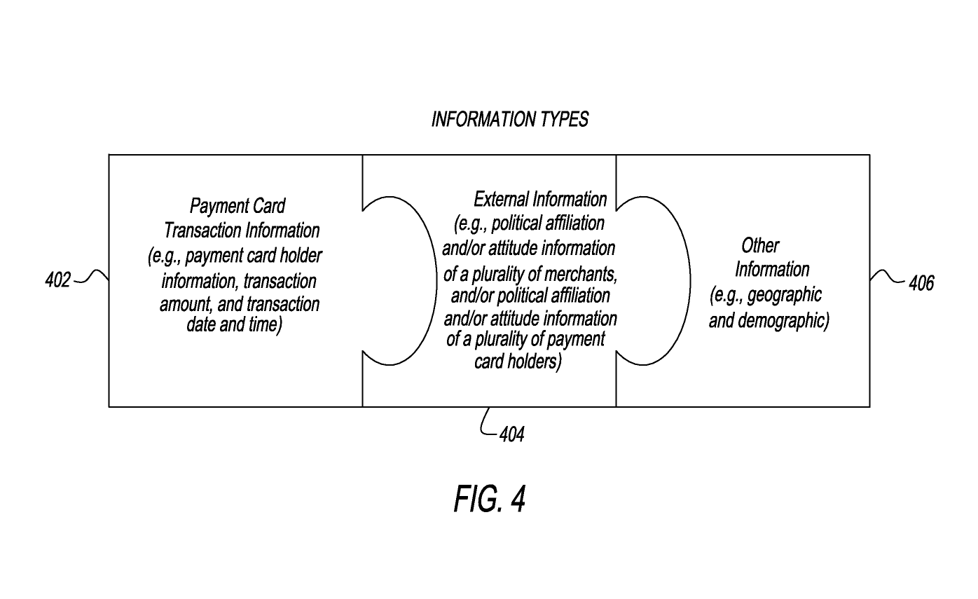

In accordance with the method of this disclosure, information that is stored in one or more databases can be retrieved (e.g., by a processor). FIG. 4 shows illustrative information types used in the systems and methods of this disclosure.

The information can include, for example, a first set of information having payment card transaction information 402. Illustrative first set of information can include, for example, transaction date and time, payment card holder information, merchant information and transaction amount. In particular, the payment card transaction information can include, for example, transaction date/time, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like), and payment transaction amount information. Information for inclusion in the first set of information can be obtained, for example, from payment card companies known as MasterCard®, Visa®, American Express®, and the like (part of the payment card company network 150 in FIG. 1).

Also, the information can include, for example, a second set of information including external information 404. Illustrative second set information can include, for example, merchant political affiliations and/or attitudes (e.g., political membership organizations, campaign donations, politically leaning charitable organizations), and payment card holder political affiliations and/or attitudes (e.g., list of payment card holders and their political affiliations, survey data, voter registration, and the like, and aggregate affiliation data such as party affiliation by geography or demographic segments). The second set of information can be categorized, for example, by party affiliation, by geography or demographic segments, and the like. The second set of information can be clustered by category, for example, by political party, political activities, events, or other categories.

The information can also contain other information 406 that includes, for example, geographic data, firmographic data, and demographic data. The other information 406 can include other suitable information that can be useful in identifying one or more associations between the payment card transaction information and the external information, determining political affiliation and/or attitude trends of the plurality of payment card holders based on the one or more associations, generating one or more predictive behavior models based on the one or more associations and the intent of the plurality of payment card holders, and assessing political affiliation and/or attitude trends of the plurality of payment card holders based on the one or more predictive behavioral models.

In an embodiment, all information stored in each of the one or more databases can be retrieved. In another embodiment, only a single entry in each database can be retrieved. The retrieval of information can be performed a single time, or can be performed multiple times. In an exemplary embodiment, only information pertaining to a specific predictive political affiliation and/or attitude profile is retrieved from each of the databases.

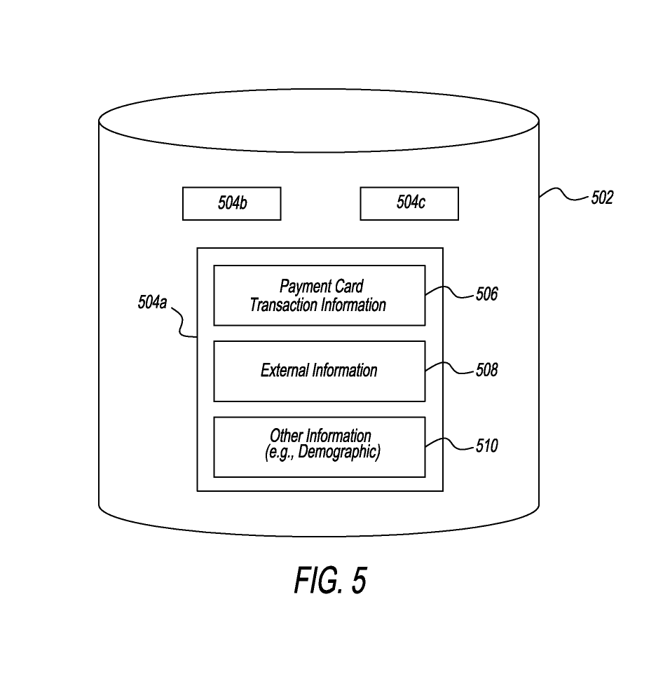

FIG. 5 illustrates an exemplary dataset 502 for the storing, reviewing, and/or analyzing of information used in the systems and methods of this disclosure. The dataset 502 can contain a plurality of entries (e.g., entries 504a, 504b, and 504c).

The payment card holder transaction information 506 includes payment card transactions and actual spending. The payment card transaction information 506 can contain, for example, transaction date/time, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like), payment transaction amount information, and the like. The external information 508 includes, for example, merchant political affiliations and/or attitudes (e.g., political membership organizations, campaign donations, politically leaning charitable organizations), and payment card holder political affiliations and/or attitudes (e.g., list of payment card holders and their political affiliations, survey data, voter registration, and the like, and aggregate affiliation data such as party affiliation by geography or demographic segments). Other information 510 can include demographic or other suitable information that can be useful in conducting the systems and methods of this disclosure.

Algorithms can be employed to determine formulaic descriptions of the integration of the payment card transaction information and the external information using any of a variety of known mathematical techniques. These formulas, in turn, can be used to derive or generate one or more analyses and updates for a political affiliation and/or attitude grouping or clustering activity using any of a variety of available trend analysis algorithms. For example, these formulas can be used to analyze the payment card transaction data and the external information to identify one or more associations between the payment card transaction information and the external information, determine political affiliation and/or attitude trends of the plurality of payment card holders based on the one or more associations, generate one or more predictive behavior models based on the one or more associations and the intent of the plurality of payment card holders, and assess political affiliation and/or attitude trends of the plurality of payment card holders based on the one or more predictive behavioral models.

In an embodiment, logic is developed for identifying one or more associations between the payment card transaction information and the external information, determining political affiliation and/or attitude trends of the plurality of payment card holders based on the one or more associations, generating one or more predictive behavior models based on the one or more associations and the intent of the plurality of payment card holders, and assessing political affiliation and/or attitude trends of the plurality of payment card holders based on the one or more predictive behavioral models. The logic is applied to a universe of payment card transaction information and external information for the various purposes described above.

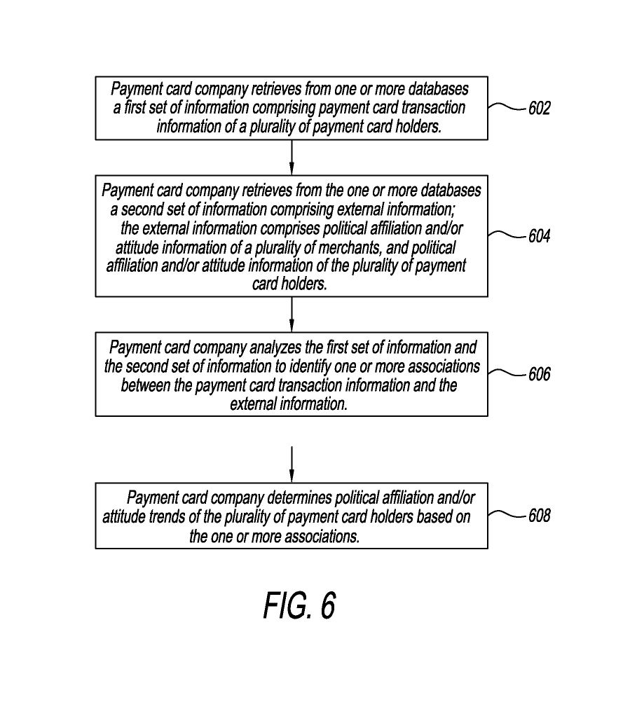

Referring to FIG. 6, the methods and the systems of this disclosure include retrieving at 602 from one or more databases a first set of information comprising payment card transaction information of a plurality of payment card holders, and retrieving at 604 from the one or more databases a second set of information comprising external information. The external information comprises political affiliation and/or attitude information of a plurality of merchants, and political affiliation and/or attitude information of the plurality of payment card holders. The method also includes analyzing at 606 the first set of information and the second set of information to identify one or more associations between the payment card transaction information and the external information; and determining at 608 political affiliation and/or attitude (e.g., ideological) trends of the plurality of payment card holders based on the one or more associations.

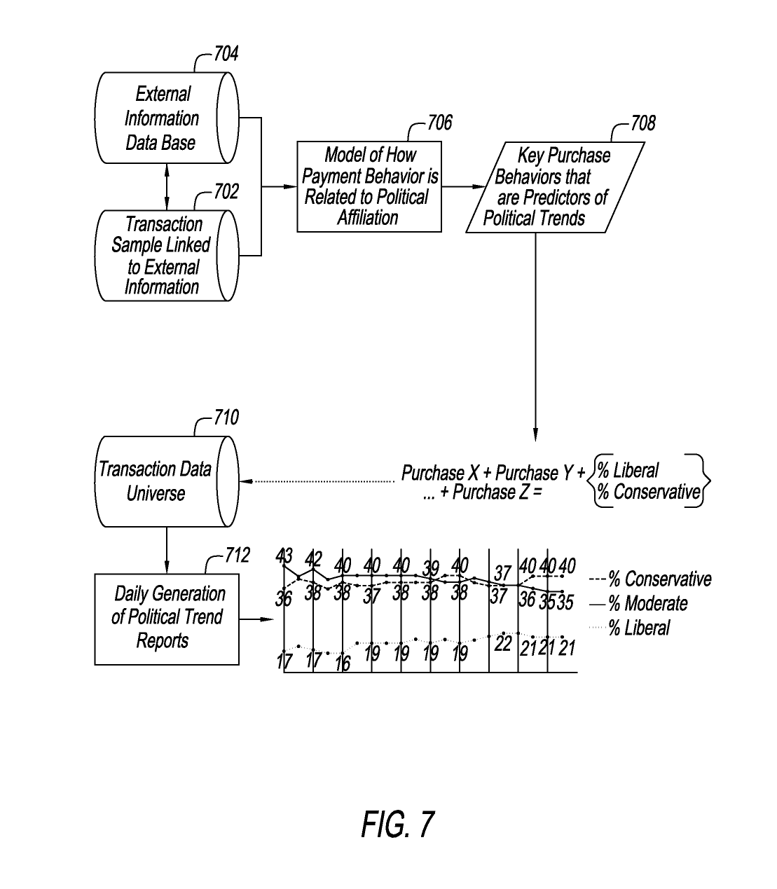

In particular, FIG. 7 is a block diagram of a method of generating political affiliation and/or attitude trends of a plurality of payment card holders, in accordance with exemplary embodiments of the present disclosure. A first set of information comprising payment card transaction information of a plurality of payment card holders is retrieved from one or more databases at 702. A second set of information comprising external information is retrieved from the one or more databases at 704. The external information comprises political affiliation and/or attitude information of a plurality of merchants, and political affiliation and/or attitude information of the plurality of payment card holders. The method also includes analyzing the first set of information and the second set of information to identify one or more associations between the payment card transaction information and the external information, and generating one or more predictive behavior models at 706 based on the one or more associations. Political affiliation and/or attitude (e.g., ideological) trends of the plurality of payment card holders based on the one or more predictive behavioral models are assessed at 708. The predictive behavioral models are applied to a universe of payment card transaction information and external information at 710 to determine political affiliation and/or attitude trends of a plurality of payment card holders. Generation of political affiliation and/or attitude trend reports are shown at 712.

The methods and the systems of this disclosure include a segment for data analysis and a segment for applying insights. In the data analysis segment, a data layout universe is constructed including, but not limited to, payment card transaction data and external data. The payment card transaction data can include, for example, transaction date/time, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like), and payment transaction amount information.

The external data can include, for example, merchant political affiliations and/or attitudes (e.g., political membership organizations, campaign donations, politically leaning charitable organizations), and payment card holder political affiliations and/or attitudes (e.g., list of payment card holders and their political affiliations, survey data, voter registration, and the like, and aggregate affiliation data such as party affiliation by geography or demographic segments).

Filters can be used for selecting certain data within the data layout universe. For example, a time range filter can be used that can vary based on need or data availability.

The data within the data layout universe is then analyzed to determine relationships between payment card transaction behavior and the external information (e.g., merchant political affiliation and/or attitude information and payment card holder political affiliation and/or attitude information). The analysis involves, for example, using standard statistical analysis techniques (e.g., clustering, regression, correlation, segmentation, raking, and the like). Logic and/or algorithms can be used in the analysis.

The data within the data layout universe is also analyzed to identify historic trends. For example, this analysis identifies which types of merchants correlate with specific political affiliations and/or attitudes, what patterns of spending are indicative of political affiliations and/or attitudes, and what patterns of spending are indicative of political interest versus ambivalence. The analysis involves, for example, using standard statistical analysis techniques (e.g., clustering, regression, correlation, segmentation, raking, and the like). Logic and/or algorithms can be used in the analysis.

In accordance with this disclosure, logic is developed for predicting political affiliation and/or attitude trends, and quantification of the political affiliation and/or attitude trends. The logic is applied to a universe of payment card transaction information and external information to determine political affiliation and/or attitude trends of a plurality of payment card holders. Algorithms can be employed to determine formulaic descriptions of the integration of the payment card transaction information and the external information using any of a variety of known mathematical techniques. For example, these formulas can be used to analyze the payment card transaction data and the external information to identify one or more associations between the payment card transaction information and the external information, and to determine political affiliation and/or attitude trends of a plurality of payment card holders based on the one or more associations.

The logic can be used to create a process for utilizing historic payment card transaction data and historic external data for predicting current and future political affiliation and/or attitude trends, and quantification of the political affiliation and/or attitude trends. The process can be composed of logic or algorithm, supporting aggregate data based on payment transaction data, supporting data from external sources, and the like. The logic can be used to predict current and future political affiliation and/or attitude trends of a plurality of payment card holders.

In the applying insights segment, the method of this disclosure can be applied to a universe of payment card transaction information and external information to determine political affiliation and/or attitude trends of a plurality of payment card holders, and measure shifts in political affiliations and/or attitudes of a plurality of payment card holders. The strength of the association between a payment card holder and political affiliation and/or attitude trends can be quantified. The output from the applying insights segment can include, for example, payment card holder identification, a date/time transaction range, quantification of political engagement of the plurality of payment card holders (e.g., how engaged are the payment card holders in politics), political affiliation and/or attitude trends of a plurality of payment card holders, quantification of the confidence of the relationship amongst the plurality of payment card holders and political affiliation and/or attitude trends (e.g., 80% confidence), measuring shifts in political affiliations and/or attitudes of the plurality of payment card holders, and the like.

For example, payment card transaction data shows that a payment card holders donate money to several Republican candidates. Based on these associations, these payment card holders are determined to be politically engaged and is determined to be aligned with the Republican Party.

In another example, payment card transaction data shows that payment card holders donate to the campaigns of several candidates of mixed political parties. Based on these associations, these payment card holders are determined to be politically engaged but do not have a strong affiliation with a single political party.

In yet another example, payment card transaction data shows that payment card holders donate to politically active organizations (e.g., League of Women Voters) but have made no payment card transactions that suggest any political party affiliation. Based on these associations, these payment card holders are determined to be politically engaged but a political affiliation cannot be determined.

In a further example, payment card holders are members of several environmental organizations, donate to national public radio (e.g., NPR), and eat out regularly at a vegan restaurant. While there are no purchases to directly indicate political affiliation, it is likely that these payment card holders are aligned with political attitudes of Democrats versus Republicans. The degree of political engagement is unknown.

One or more predictive behavioral models can be generated based on the associations between the payment card transaction information and the external information. The predictive behavioral models are discussed more fully hereinbelow.

The above examples illustrate how the systems and the methods of this disclosure can be used to make associations between payment card holder transaction information and external information. In particular, the systems and the methods of this disclosure can be used to predict political affiliation and/or attitude trends in a population, and measure shifts in political affiliations and/or attitudes of a population. The method and system can also be used for research purposes.

As indicated herein, the systems and the methods of this disclosure use standard statistical techniques (e.g., clustering, regression, correlation, segmentation, raking, and the like) to identify one or more associations between the payment card transaction information and the external information. The associations or relationships can be refined by looking at factors such as time, frequency, and the like.

Logic can be created for associating the payment card transaction information and the external information and then quantifying their relationship (e.g., confidence quantifier). Once the logic has been created, it can be applied to the universe of payment card transaction information and external information to determine political affiliation and/or attitude trends of a plurality of payment card holders. Attributes (e.g., confidence, time, frequency, and the like) can then be assigned to the plurality of payment card holders to make the data useful to potential end users such as pollsters.

In accordance with this disclosure, one or more predictive behavioral models are generated based at least in part on the first set of information and the second set of information. Predictive behavioral models can be selected based on the information obtained and stored in the one or more databases. The selection of information for representation in the predictive behavioral models can be different in every instance. In one embodiment, all information stored in each database can be used for selecting predictive behavioral models. In an alternative embodiment, only a portion of the information is used. The generation and selection of predictive behavioral models can be based on specific criteria.

Predictive behavioral models are generated from the information obtained from each database. The information is analyzed, extracted and correlated by, for example, a financial transaction processing company (e.g., a payment card company), and can include financial account information, merchant information, performing statistical analysis on financial account information and merchant information, finding correlations between account information, merchant information and payment card holder behaviors, predicting future payment card holder behaviors based on account information and merchant information, determining political affiliation and/or attitude trends of the plurality of payment card holders, and the like.

Activities and characteristics attributable to the payment card holders based on the one or more predictive behavioral models are identified. The payment card holders have a propensity to carry out certain activities and to exhibit certain characteristics, based on the one or more predictive behavioral models. The activities and characteristics attributable to the payment card holders and based on the one or more predictive behavioral models are conveyed by the financial transaction processing entity to an entity (e.g., pollster, and the like) to take appropriate action, for example, generating a report of political affiliation and/or attitude trends in a population and/or measuring shifts in political affiliations and/or attitudes of a population. The generating of the report can be performed by any suitable method as will be apparent to persons having skill in the relevant art.

Predictive behavioral models can be defined based on geographical or demographical information including, but not limited to, age, gender, income, marital status, postal code, income, spending propensity, and familial status. In some embodiments, predictive behavioral models can be defined by a plurality of geographical and/or demographical categories. For example, a predictive behavioral model can be defined for any payment card holder who engages in purchasing and spending activity.

Predictive behavioral models can also be based on behavioral variables. For example, the financial transaction processing entity database can store information relating to financial transactions. The information can be used to determine an individual's likeliness to spend at a particular date and time. An individual's likeliness to spend can be represented generally, or with respect to a particular industry, retailer, brand, or any other criteria that can be suitable as will be apparent to persons having skill in the relevant art. An individual's behavior can also be based on additional factors, including but not limited to, time, location, and season. The factors and behaviors identified can vary widely and can be based on the application of the information.

Behavioral variables can also be applied to generated predictive behavioral models based on the attributes of the entities. For example, a predictive behavioral model of specific geographical and demographical attributes can be analyzed for spending behaviors. Results of the analysis can be assigned to the predictive behavioral models.

In an embodiment, the information retrieved from each of the databases can be analyzed to determine behavioral information of the payment card holders. Also, information related to an intent of the payment card holders can be extracted from the behavioral information. The predictive behavioral models can be based upon the behavioral information of the payment card holders and the intent of the payment card holders. The predictive behavioral models can be capable of predicting behavior and intent in the payment card holders.

In analyzing information to determine behavioral information, intent and other payment card holder attributes are considered. Developing intent of payment card holders involves models that predict specific spend behavior at certain times in the future and desirable spend behaviors.

The one or more predictive behavioral models are capable of predicting behavior and intent in the plurality of payment card holders. The plurality of payment card holders are people and/or businesses; the activities attributable to the plurality of payment card holders are purchasing and spending transactions; and the characteristics attributable to the plurality of payment card holders are demographics and/or geographical characteristics.

A behavioral propensity score can be used for conveying to the entity the activities and characteristics attributable to the plurality of payment card holders based on the one or more predictive behavioral models. The behavioral propensity score is indicative of a propensity to exhibit a certain behavior.

A financial transaction processing company can analyze the generated predictive behavioral models (e.g., by analyzing the stored data for each entity comprising the predictive behavioral model) for behavioral information (e.g., spend behaviors and propensities). In some embodiments, the behavioral information can be represented by a behavioral propensity score. Behavioral information can be assigned to each corresponding predictive behavioral model.

Predictive behavioral models or behavioral information can be updated or refreshed at a specified time (e.g., on a regular basis or upon request of a party). Updating predictive behavioral models can include updating the population segments or entities included in each predictive behavioral model with updated demographic data and/or updated financial data. Predictive behavioral models can also be updated by changing the attributes that define each predictive behavioral model, and generating a different set of behaviors. The process for updating behavioral information can depend on the circumstances regarding the need for the information itself

Although the above methods and processes are disclosed primarily with reference to financial data and spending behaviors, it will be apparent to persons having skill in the relevant art that the predictive behavioral models can be beneficial in a variety of other applications. Predictive behavioral models can be useful in the evaluation of consumer data that may need to be protected.

The payment card company analyzes the first set of information and second set of information to determine behavioral information of the payment card holders. The payment card company extracts information related to intent of the payment card holders from the behavioral information.

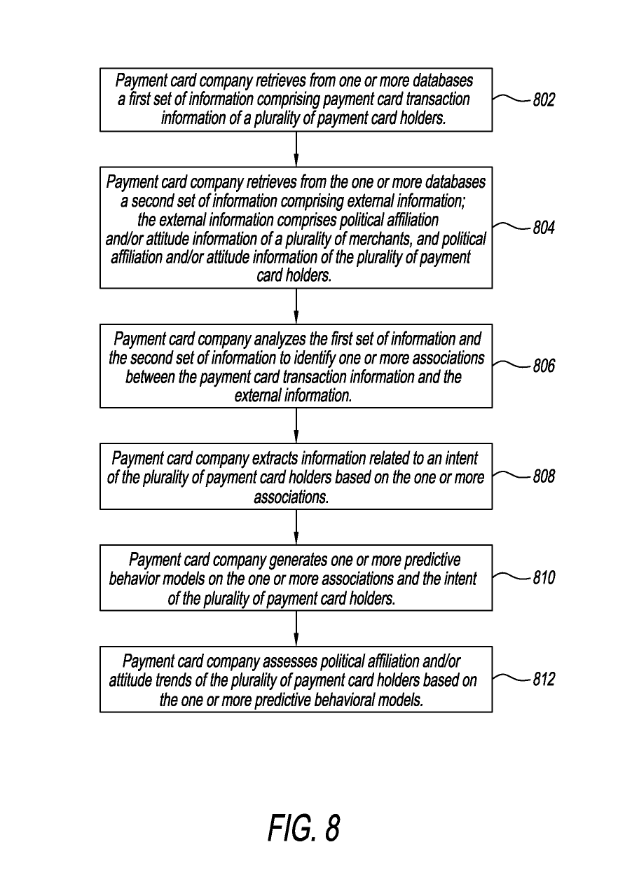

FIG. 8 is a flow chart illustrating a method of assessing political affiliation and/or attitude trends of a plurality of payment card holders based on predictive behavioral models, in accordance with exemplary embodiments of the present disclosure. The method includes retrieving at 802 from one or more databases a first set of information comprising payment card transaction information, and retrieving at 804 from one or more databases a second set of information comprising external information. The external information has merchant political affiliation and/or attitude information and payment card holder political affiliation and/or attitude information. The method also includes analyzing at 806 the first set of information and the second set of information to identify one or more associations between the payment card transaction information and the external information. At 808, information is extracted related to an intent of the plurality of payment card holders based on the one or more associations. The method further includes generating at 810 one or more predictive behavior models based on the one or more associations and the intent of the plurality of payment card holders, and assessing at 812 political affiliation and/or attitude (e.g., ideological) trends of the plurality of payment card holders based on the one or more predictive behavioral models.

It will be understood that the present disclosure can be embodied in a computer readable non-transitory storage medium storing instructions of a computer program that when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
retrieving from one or more databases a first set of information comprising payment card transaction information of a plurality of payment card holders;
retrieving from the one or more databases a second set of information comprising external information, wherein the external information comprises political affiliation and/or attitude information of a plurality of merchants, and political affiliation and/or attitude information of the plurality of payment card holders;
analyzing the first set of information and the second set of information to identify one or more associations between the payment card transaction information and the external information; and
determining political affiliation and/or attitude trends of the plurality of payment card holders based on the one or more associations.

2. The method of claim 1, further comprising developing logic for predicting political affiliation and/or attitude trends, and applying the logic to a universe of payment card transaction information and external information to determine political affiliation and/or attitude trends of the plurality of payment card holders.

3. The method of claim 1, further comprising quantifying strength of the political affiliation and/or attitude trends of the plurality of payment card holders.

4. The method of claim 1, further comprising assigning attributes to the plurality of payment card holders with respect to the political affiliation and/or attitude trends of the plurality of payment card holders, wherein the attributes are selected from the group consisting of one or more of confidence, frequency, and time.

5. The method of claim 1, further comprising identifying the plurality of payment card holders, identifying a date/time transaction range, quantifying political engagement of the plurality of payment card holders, identifying political affiliation and/or attitude trends of the plurality of payment card holders, and/or quantifying the strength of the relationship between the plurality of payment card holders and political affiliation and/or attitude trends.

6. The method of claim 1, further comprising defining the plurality of payment card holders based on geographical and/or demographical information with respect to the political affiliation and/or attitude trends of the plurality of payment card holders.

7. The method of claim 1, wherein the payment card transaction information comprises transaction date and time, payment card holder information, merchant information and transaction amount.

8. The method of claim 1, wherein the political affiliation and/or attitude information of the plurality of merchants comprises political membership organization information, campaign donation information and politically leaning charitable organization information, and wherein the political affiliation and/or attitude information of the plurality of payment card holders comprises a list of payment card holders and their political affiliations, survey data and voter registration information.

9. The method of claim 1, wherein the political affiliation and/or attitude trends of the plurality of payment card holders is determined by statistical analysis selected from the group consisting of clustering, regression, correlation, segmentation, and raking.

10. A system comprising:
one or more databases including a first set of information comprising payment card transaction information of a plurality of payment card holders;
one or more databases including a second set of information comprising external information, wherein the external information comprises political affiliation and/or attitude information of a plurality of merchants, and political affiliation and/or attitude information of the plurality of payment card holders; and
a processor configured to:
analyze the first set of information and the second set of information to identify one or more associations between the payment card transaction information and the external information; and
determine political affiliation and/or attitude trends of the plurality of payment card holders based on the one or more associations.

11. The system of claim 10, wherein the processor has a programmed logic to predict political affiliation and/or attitude trends, and wherein the logic is applied to a universe of payment card transaction information and external information to determine political affiliation and/or attitude trends of the plurality of payment card holders.

12. The system of claim 10, wherein the processor quantifies strength of the political affiliation and/or attitude trends of the plurality of payment card holders.

13. The system of claim 10, wherein the processor assigns attributes to the plurality of payment card holders with respect to the political affiliation and/or attitude trends of the plurality of payment card holders, and wherein the attributes are selected from the group consisting of one or more of confidence, frequency, and time.

14. The system of claim 10, wherein the processor is configured to perform one or more of the functions selected from the group consisting of: identifies the plurality of payment card holders; identifies a date/time transaction range; quantifies political engagement of the plurality of payment card holders; identifies political affiliation and/or attitude trends of the plurality of payment card holders; and quantifies strength of the relationship between the plurality of payment card holders and political affiliation and/or attitude trends.

15. The system of claim 10, wherein the processor defines the plurality of payment card holders based on geographical and/or demographical information with respect to the political affiliation and/or attitude trends of the plurality of payment card holders.

16. The system of claim 10, wherein the payment card transaction information comprises transaction date and time, payment card holder information, merchant information and transaction amount.

17. The system of claim 10, wherein the political affiliation and/or attitude information of the plurality of merchants comprises political membership organization information, campaign donation information and politically leaning charitable organization information, and wherein the political affiliation and/or attitude information of the plurality of payment card holders comprises a list of payment card holders and their political affiliations, survey data and voter registration information.

18. The system of claim 10, wherein the political affiliation and/or attitude trends of the plurality of payment card holders is determined by statistical analysis selected from the group consisting of clustering, regression, correlation, segmentation, and raking.

19. A method comprising:
retrieving from one or more databases a first set of information comprising payment card transaction information of a plurality of payment card holders;
retrieving from the one or more databases a second set of information comprising external information, wherein the external information comprises political affiliation and/or attitude information of a plurality of merchants, and political affiliation and/or attitude information of the plurality of payment card holders;
analyzing the first set of information and the second set of information to identify one or more associations between the payment card transaction information and the external information;
extracting information related to an intent of the plurality of payment card holders based on the one or more associations;
generating one or more predictive behavior models based on the one or more associations and the intent of the plurality of payment card holders; and
assessing political affiliation and/or attitude trends of the plurality of payment card holders based on the one or more predictive behavioral models.

20. The method of claim 19, further comprising determining political affiliation or attitude trends of the plurality of payment card holders based on the one or more predictive behavioral models.

21. The method of claim 19, further comprising defining the plurality of payment card holders based on geographical and/or demographical information with respect to the political affiliation and/or attitude trends of the plurality of payment card holders.
